(19) United States
(12) Patent Application Publication
(10) Pub. No.: US 2012/0079715 A1
(43) Pub. Date: Apr. 5, 2012

(54) TWEEZER FOR DETACHING CONNECTOR

(75) Inventor: JIN-SEN CHEN, Foshan (CN)

(73) Assignees: HON HAI PRECISION INDUSTRY CO., LTD., Tu-Cheng (TW); PREMIER IMAGE TECHNOLOGY(CHINA) LTD., Foshan City (CN)

(21) Appl. No.: 12/978,326

(22) Filed: Dec. 23, 2010

(30) Foreign Application Priority Data
Sep. 30, 2010 (CN) 201010298699.6

(51) Int. Cl. B25B 9/00

(52) U.S. Cl. 29/764

(57) ABSTRACT

A tweezer for detaching a connector includes a pivot and two levers connected to each other by the pivot. Each lever includes a connection surface facing another lever and a holding end, and defines an elongated groove in the connection surface at the holding end. The elongated grooves of the two levers extend along a direction substantially parallel to the pivot. The elongated grooves are configured for receiving two opposite edges of the connector such that the two levers cooperatively grasp the connector.

### BACKGROUND

1. Technical Field

The present disclosure relates to tweezers and, particularly, to a tweezer for detaching a connector from another connector.

2. Description of Related Art

Some male connectors include a substrate and an array of pins perpendicularly protruding from a surface of the substrate. In use, the pins insert into and tightly engage with a corresponding female connector to form a reliable connection therebetween. However, it is difficult to detach the male connector from the female connector, if needed, without damaging the tightly engaged pins by hand or conventional tweezers since a detaching force applied to the edge of the substrate may bend or break some of the pins.

Therefore, it is desirable to provide a tweezer, which can overcome the limitations described.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the views.

FIG. 1 is an isometric, exploded, and schematic view of a tweezer, according to an embodiment.

FIG. 2 is an assembled view of the tweezer of FIG. 1, which is used to detach a connector from another connector.

FIG. 3 is similar to FIG. 2, but showing that the connector is detached.

### DETAILED DESCRIPTION

Embodiments of the present disclosure will now be described in detail with reference to the drawings.

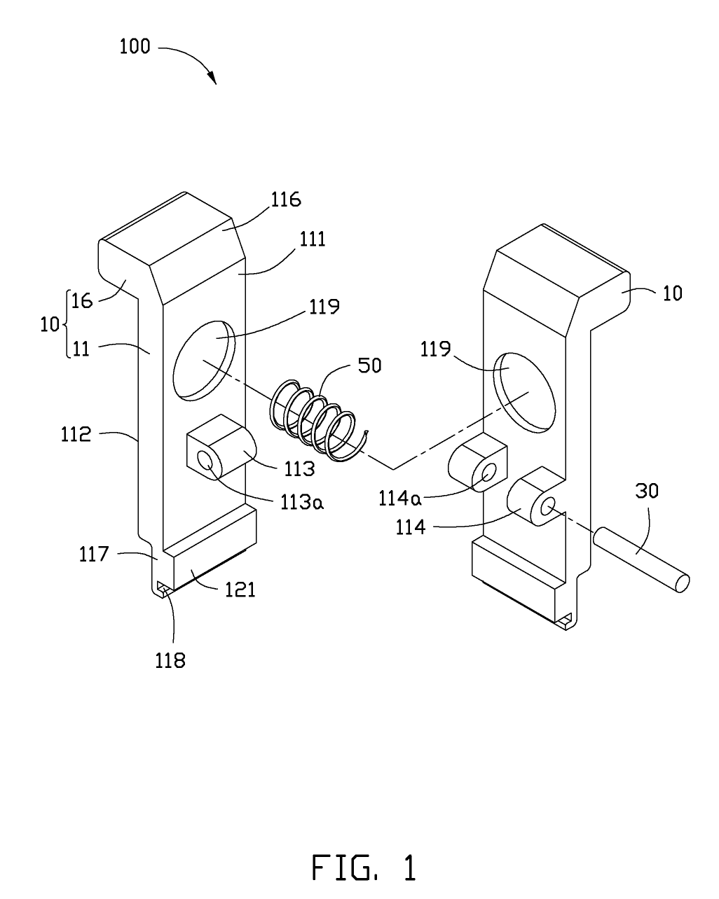

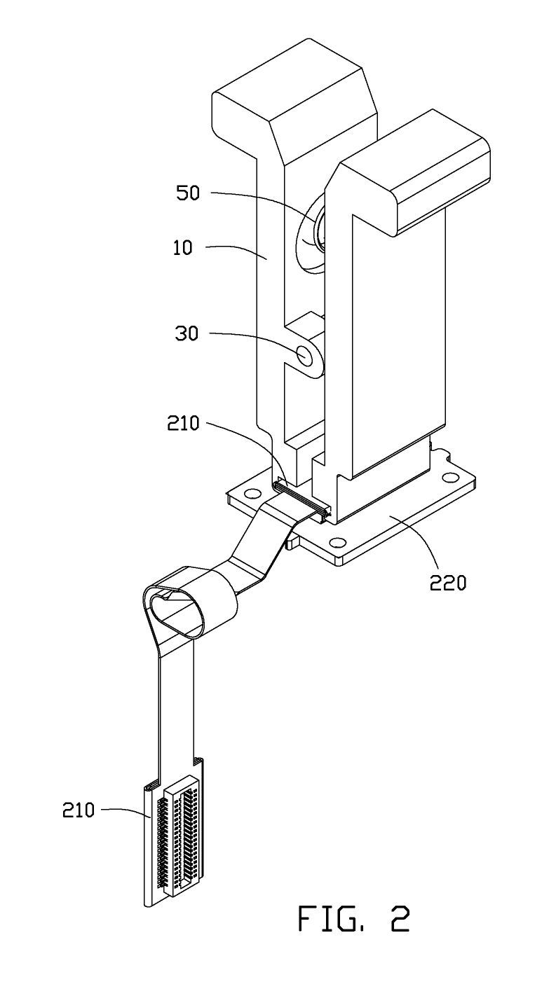

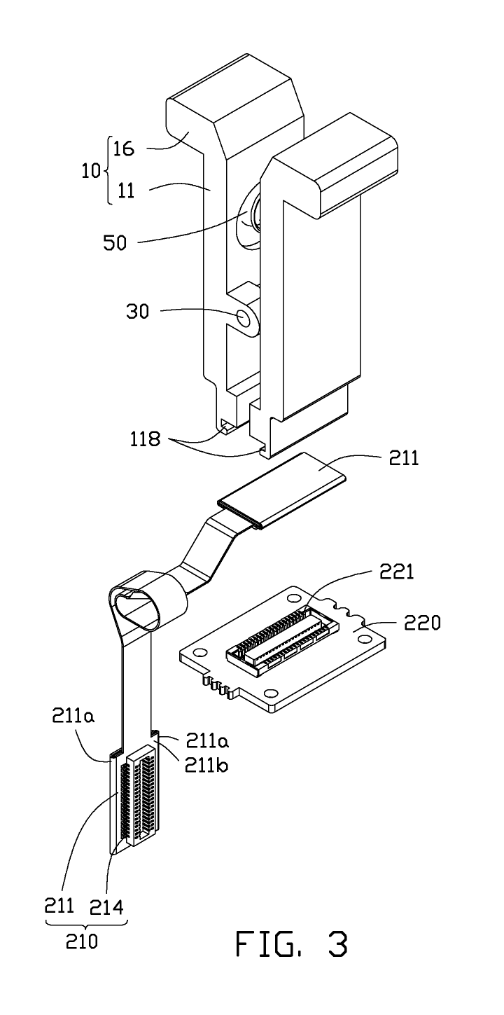

Referring to FIGS. 1-3, a tweezer 100, according to one embodiment, is configured for detaching a connector, such as a male connector 210, from another connector, such as a female connector 220. The male connector 210 includes a substantially rectangular substrate 211 and a number of pins 214 protruding from a surface 211b of the substrate 211. The substrate 211 has two opposite lengthwise edges 211a. The female connector 220 forms a number of grooves 221 corresponding to the pins 214. In use, the pins 214 insert and tightly engage with the grooves 221 to form a reliable connection between the male connector 210 and the female connector 220.

The tweezer 100 includes two levers 10, a pivot 30, and an elastic member 50.

Each lever 10 includes a main body 11, an operation portion 16, and a reinforcement portion 121. One lever 10 has a first fulcrum portion 113, and another has two second fulcrum portions 114.

Each main body 11 is substantially a rectangular bar in shape and includes an operation end 116, a holding end 117 opposite to the operation end 116, a connection surface 111 connecting the operation end 116 and the holding end 117, and a non-connection surface 112 opposite to the connection surface 111. Each main body 11 also defines a recess 119, such as a circular recess, in the connection surface 111, generally at the center in the widthwise direction and slightly adjacent to the operation end 116 in the lengthwise direction of the connection surface 111.

Each operation portion 16 is substantially a block and perpendicularly extends from the corresponding non-connection surface 112, at the corresponding operation end 116.

Each reinforcement portion 121 is substantially a block extending from the corresponding connection surface 111, at the corresponding holding end 117. Each reinforcement portion 121 is thicker than the corresponding main body 11 and defines an elongated groove 118 in a surface thereof opposite to the corresponding non-connection surface 112 at an end distant from the corresponding main body 11. Each elongated groove 118 extends along a direction substantially perpendicular to the lengthwise direction of the corresponding connecting surface 111 and through the corresponding reinforcement portion 121. The width of the elongated grooves 118 is slightly larger than the thickness of the substrate 211 and the length of the elongated grooves 118 is equal to or slightly longer than the two lengthwise edges 211a.

The first fulcrum portion 113 and the second fulcrum portions 114 are substantially similar to each other and both have a cubic bottom and a semi-cylindrical top. The first fulcrum portion 113 extends upward from the corresponding connection surface 111, generally at the center widthwise and slightly adjacent to the holding end 117 lengthwise, and defines a first fulcrum hole 113a, such as a circular hole, therethrough. The depthwise direction of the first fulcrum hole 113a is substantially perpendicular to the lengthwise direction of the corresponding connection surface 111. The second fulcrum portions 114 extend upward from the corresponding connection surface 111, respectively at two sides of the corresponding connection surface 111, and are adjacent to the holding end 117. Each of the second fulcrum portions 114 defines a second fulcrum hole 114a, such as a circular hole, therethrough. The depthwise direction of the second fulcrum holes 114a is also substantially perpendicular to the lengthwise direction of the corresponding connection surface 111.

In assembly, the first fulcrum portion 113 fits into the gap defined between the two second fulcrum portions 114 until the first fulcrum hole 113a aligns with the second fulcrum holes 114a. Then, the pivot 30 such as a circular rod fits into the second fulcrum holes 114s and the first fulcrum hole 113a. Thus, the two levers 11 pivotably connect together. The elastic member 50 such as a coil spring is compressed, and two ends (not labeled) thereof are received in the respective recess 119 and connect to the respective main bodies 11. Due to the elastic restoration force of the elastic member 50, the reinforcement portions 121 abut against each other.

In use, the operation portions 16 are pushed to move toward each other such that the levers 10 turn on the pivot 30 until the distance between the two elongated grooves 118 is greater than the width of the substrate 211. Then, the tweezer 100 is moved to where the elongated grooves 118 align with the respective lengthwise edges 211 a and the operation portions 16 are released such that the elongated grooves 118 fit into the respective lengthwise edges 211a. The tweezer 100 grasps the male connector 210. A detaching force is applied to the tweezer 100, and then the male connector 210 is detached from the female connector 220.

The levers 10 can be pivotably connected to each other by other structures and therefore are not limited to this embodiment.

The reinforcement portions 121 are employed to mechanically reinforce the respective holding ends 117 and can be omitted in some other embodiments, provided that the mechanical strength of the holding ends satisfy application requirements. In these embodiments, the elongated grooves 118 can be directly defined in the respective connection surfaces 111 at the respective holding ends 117.

The operation portions 16 are for facilitating the operation of the respective operation ends 116 and can be omitted if a simpler lower cost tweezer 100 is required in some other embodiments. In these embodiments, the operation ends 116 can be directly operated.

The recesses 19 are configured to reduce the minimal distance between the operation ends 116 and can be omitted in some other embodiments depending on needs. The elastic member 50 is employed to cause the tweezer 100 to automatically hold onto the substrate 210 after the operation portions 16 are released. However, if a simpler lower cost tweezer 100 is required, the elastic member 50 can be omitted.

It will be understood that the above particular embodiments are shown and described by way of illustration only. The principles and the features of the present disclosure may be employed in various and numerous embodiment thereof without departing from the scope of the disclosure as claimed. The above-described embodiments illustrate the scope of the disclosure but do not restrict the scope of the disclosure.

What is claimed is:

1. A tweezer for detaching a connector, comprising:
a pivot; and
two levers connected with each other via the pivot, each lever comprising a connection surface and a holding end, and defining an elongated groove in the connection surface at the holding end; the elongated grooves of the two levers extending along a direction substantially parallel to the pivot and configured for receiving two opposite edges of the connector such that the two levers cooperatively grasp the connector.

2. The tweezer of claim 1, wherein a first fulcrum portion extends from the connection surface of one lever, two second fulcrum portions extend from the connection surface of another lever, the first fulcrum portion defines a first fulcrum hole, each second fulcrum portion defines a second fulcrum hole, the first fulcrum portion fits into the gap defined between the second fulcrum portions such that the first fulcrum hole aligns with the second fulcrum holes, and the pivot inserts through the second fulcrum holes and the first fulcrum holes.

3. The tweezer of claim 2, wherein the first fulcrum portion is located at the center in the widthwise direction of the connection surface and slightly adjacent to the holding end in the lengthwise direction of the connection surface.

4. The tweezer of claim 2, wherein the second connection portions are located at two sides in the widthwise direction of the connection surface and slightly adjacent to the holding end in the lengthwise direction of the connection surface.

5. The tweezer of claim 1, wherein each lever comprises a reinforcement portion extending from the connection surface at the holding end, and each elongated groove is defined in the respective reinforcement portion.

6. The tweezer of claim 1, wherein each lever comprises a non-connection surface opposite to the connection surface and an operation portion extending from the non-connection surface and opposite to the holding end.

7. The tweezer of claim 1, wherein the length of each elongated groove is equal to or slightly larger than the length of the two opposite edges of the connector.

8. The tweezer of claim 1, further comprising an elastic member, wherein the elastic member is connected between the levers and is adjacent to an end of each lever opposite to the holding end, the elastic member is capable of being compressed by the two levers.

9. The tweezer of claim 8, wherein each lever defines a recess in the connection surface thereof to receive the elastic member.
